(19) United States
(12) Patent Application Publication
(10) Pub. No.: US 2015/0138354 A1
(43) Pub. Date: May 21, 2015

(54) METHOD AND SYSTEM FOR COMMUNICATING EQUIPMENT FIELD DATA TO SERVICE CENTERS

(71) Applicant: James Miller, Littleton, CO (US)

(72) Inventor: James Miller, Littleton, CO (US)

(21) Appl. No.: 14/299,923

(22) Filed: Jun. 9, 2014

Related U.S. Application Data
(60) Provisional application No. 61/907,042, filed on Nov. 21, 2013.

(51) Int. Cl. G06Q 10/00; H04N 7/18

(52) U.S. Cl. CPC G06Q 10/20; H04N 7/183
USPC 348/143

(57) ABSTRACT

A method and system for providing efficient repair of mining equipment includes providing an electronic device having a camera, a microphone and geolocation determining hardware and software. The method includes capturing an image and sound of the mining equipment in need of repair along with the geolocation of the mining equipment, and automatically dispatching an electronic message including the captured image, sound and geolocation data to an electronic address of a service center. The automatic dispatch of the electronic message occurs without need of further action by an operator of the electronic device, and the timing of the dispatch is instantly, or when a network connection becomes available. In one embodiment of the invention the electronic device is integrated in a wearable device such as a hard hat.

### FIELD OF THE INVENTION

This invention pertains to methods and systems for gathering and distributing field data relating to mining equipment and infrastructure used in mining operations to optimize reliability and to minimize down time, and particularly distributing field equipment data including images and sounds.

### BACKGROUND OF THE INVENTION

Mining is highly reliant on heavy equipment, and other assets that are required for removing, transporting and processing earth, minerals and mining products. Often equipment utilizes consumable parts, such as drill bits, belts, hoses, gauges, connectors and numerous other components. These wear, fail, and periodically require replacement or repair.

This equipment is subject to great loads, and less-than-optimal operating conditions. Virtually any piece of equipment can wear, requiring maintenance, or fail. In most cases the cost of repair is significant, but the costs of downtime and production delays in mining operations are critical, and must be adequately managed.

Typically, when equipment fails a site engineer is called to inspect the equipment and assess the problem. After the inspection, the site engineer returns to an area where a phone conversation can be had.

A discussion with an equipment part supplier or other service professional may yield questions such as name tag information for the machine to be repaired, and a detailed description of the part that has failed. This process takes time and may require the site engineer to return to the failed equipment several times to gather the information required to order any parts required for repair. If the site is remote, much time can be lost. The time lost during this process costs the mining operation significantly.

These same issues arise in various industries including energy and telecommunications. Power plants have generation and transmission components that require maintenance, and the costs of down-time are significant. Telecommunications systems require transmission infrastructure maintenance and repair. Any effort to minimize down-time has significant value, particularly for equipment that requires repairs and maintenance in hard to reach locations.

What is desired is a way of streamlining processes of repairing and maintaining equipment in the field to minimize downtime of industrial operations, including mining operations.

### SUMMARY OF THE INVENTION

A method of providing efficient repair of capital equipment includes providing an electronic device having a camera and a microphone, and enabling a service technician to use the electronic device to capture an image and sound of capital equipment, such as mining equipment, in need of repair.

The method includes programming the electronic device with software and employing the software to automatically dispatch an electronic message including the captured image or sound, or both, to an electronic address of a service center.

The automatic dispatch of an electronic message occurs whenever an image is captured, so one instruction or command to the electronic device results in both the capture of an image and the dispatch of an electronic message.

In an alternate embodiment, the image includes a series of images in the form of a video clip and sound associated with the video clip. In another alternate embodiment, a sound clip capture feature is enabled so that the entry of a single command i.e. sound capture, results in both capturing a sound for a period of time and automatically transmitting a digital representation of the sound, for example in a .wav formatted file. The period of time may be pre-determined to be in the range of 5-10 seconds for example, or it may be modified by a user operating the electronic device.

In one embodiment, the electronic device has a user interface. The user interface includes a send button, which is either a physical button, or a button programmed to appear on a touch screen of the electronic device. The method includes enabling actuation of the send button to automatically dispatch an electronic message including the captured image and sound file. In this embodiment, the capture and dispatch of the image occur in separate steps. The electronic address to which the electronic message is pre-programmed. This saves time by enabling a user to skip any step requiring selection of an electronic address.

In one embodiment, the capital equipment includes a tag having details describing the equipment, i.e. serial number, or model number. The electronic device is programmed to read serial numbers and model numbers from the tag. Additionally, where the tag has a bar code, such as a data matrix bar code, then the data from the bar code is read by the electronic device and communicated in the electronic message.

In an alternate embodiment the capital equipment includes a Radio Frequency Identification Tag (RFID), and the electronic device includes an RFID tag reader. Accordingly, data stored on the RFID tag, i.e. serial number and model number, are automatically communicated with the image or sound clip from the electronic device.

Preferably the electronic address for the data transmitted from the electronic device is that of a service center having a server. The transmitted data is processed by the service center server. The service center server includes bar code reading capability to read bar codes from images communicated to the server from the electronic device. The service center server, in an alternate embodiment, is configured with software to identify and convert raw data from an RFID tag format into useable data that can be stored in a customer relations management (CRM) database in operative communication with the server.

In one embodiment, the server automatically detects bar codes in images and converts the data stored on the bar code into alpha-numeric data readable by a service center technician.

In another embodiment, the server includes optical character reading (OCR) software, and the server utilizes the OCR to read an image of the tag and convert the information on the tag into alpha-numeric data, for storage in the CRM database.

Thus any optically read data from images of a tag, and the tag image, is stored in the customer relations database and stored along with associated data. Associated data includes a customer name, company, location, service history, and field technician contact information.

The server includes a service center database connected in operative communication with a library database. Data from the alpha-numeric tag, bar code, or RFID tag enables the service center database to assemble data from the library database, wherein the assembled data includes a parts list for the capital equipment to be repaired. The service center database communicates the parts list to the service center technician to enable parts to be ordered and services scheduled.

In one embodiment, electronic device includes a microphone, and the method includes recording sounds made by the capital equipment in need of repair, and automatically dispatching an electronic message including the sounds to an electronic address of a service center.

The electronic device is a smart phone in one embodiment of the invention, in another embodiment of the invention the electronic device is a wearable device.

The wearable device is a smart wristwatch in one variation of the invention. In another embodiment, the wearable device is a pair of smart glasses such as Google™ Glasses. In yet another embodiment, the electronic device is integrated into a hard hat, having stereoscopic cameras and a microphone.

The present invention includes a system for troubleshooting capital equipment including mining equipment, transmission lines, bridges, and power plants. The system includes a service center server having a server.

A customer relations management (CRM) database is in operative communication with the server. A library database is in operative communication with the customer relations management (CRM) database. The library database stores parts lists, part numbers and images of parts for the capital equipment.

An electronic device used by a field technician is in operative communication with the server via a cellular network, satellite network, or other wireless network. The electronic device including a camera and microphone for capturing images and sounds of the capital equipment. The electronic device includes a data communication terminal for communicating data captured by the electronic device to the server.

The electronic device is programmed to store an electronic address of a service center, and to automatically dispatch images from the camera, and sounds recorded by the microphone, to the service center server. Images captured by the camera are automatically dispatched to the service center.

The electronic device include Global Positioning System (GPS) components or similar location system hardware that enables GPS communication capability for determining location of the electronic device, and the capital equipment location where images, sound and other data are collected. The data communications terminal automatically communicates the location of the electronic device to the service center server with any electronic communication between the electronic device and the server. The service center server utilizes the location of the electronic device to determine the customer, the company, the location, and other data, and associates the images and sounds in the electronic communication with a customer in the customer relations management (CRM) database.

### BRIEF DESCRIPTION OF THE DRAWINGS

FIG. 1 shows a system in accordance with the present invention.

FIG. 2 shows a detailed layout of a system in accordance with the present invention.

FIG. 3 shows a flowchart of a method in accordance with the present invention.

FIG. 4 shows an image of a bridge inspector inspecting a truss bridge.

FIG. 5 shows an image of capital equipment on location in a mining operation.

FIG. 6 shows an electronic device and interface.

FIG. 7 shows a hard hat with an integrated electronic device, cameras and a microphone.

### DETAILED DESCRIPTION

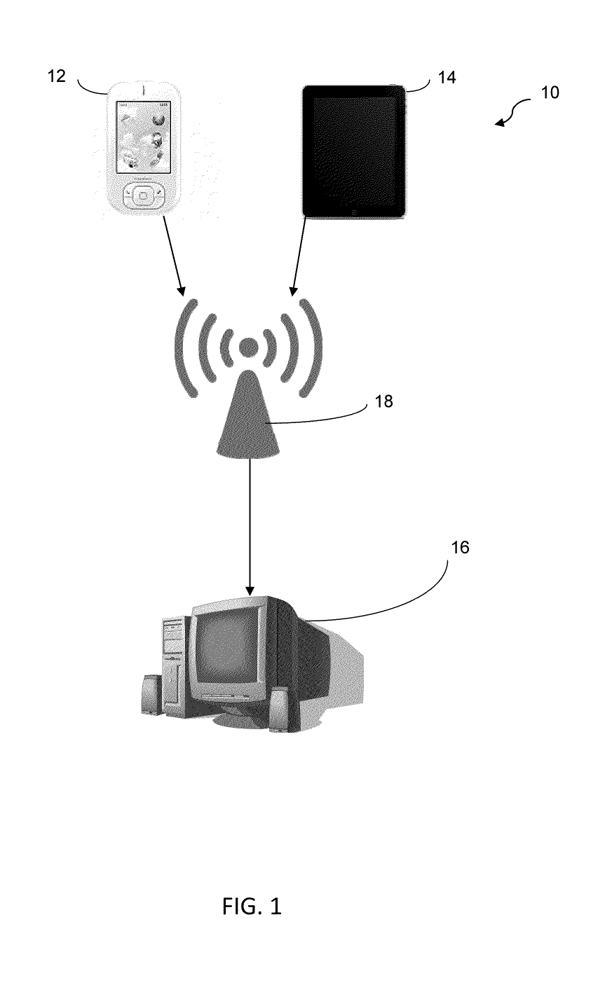

FIG. 1 is a system in accordance with the present invention. The system is generally designated with the reference numeral 10. The system 10 includes portable electronic devices. Examples of electronic device used with the present system, include a smart phone 12 and a tablet computer 14. Further examples of electronic devices in accordance with the present invention include wearable electronic devices including glasses, wrist watch-style devices and hard hats having integrated electronics and a camera.

The system 10 also includes a network 18 such as a cellular data network, or satellite-based data network, capable of communicating data over distances of many miles. The system 10 includes a database server 16 that includes a customer relations management database, and communicates with a library database. The network 18 enables operative communication between the electronic devices and the server 16.

Although a smart phone 12 and tablet computer 14 are shown in FIG. 1, it can be appreciated that numerous devices can be adapted for use with the present invention. For example a gauss meter can be adapted with a camera, microphone and communications interface for use with the power distribution system diagnostics and testing. Devices for measuring current, impedance and voltage can also be adapted for use with the present invention. Further, devices with vibration sensing capability, including an accelerometer can be use with the present invention. These are just a subset of examples of a limited number of devices that can be adapted for use with the present invention.

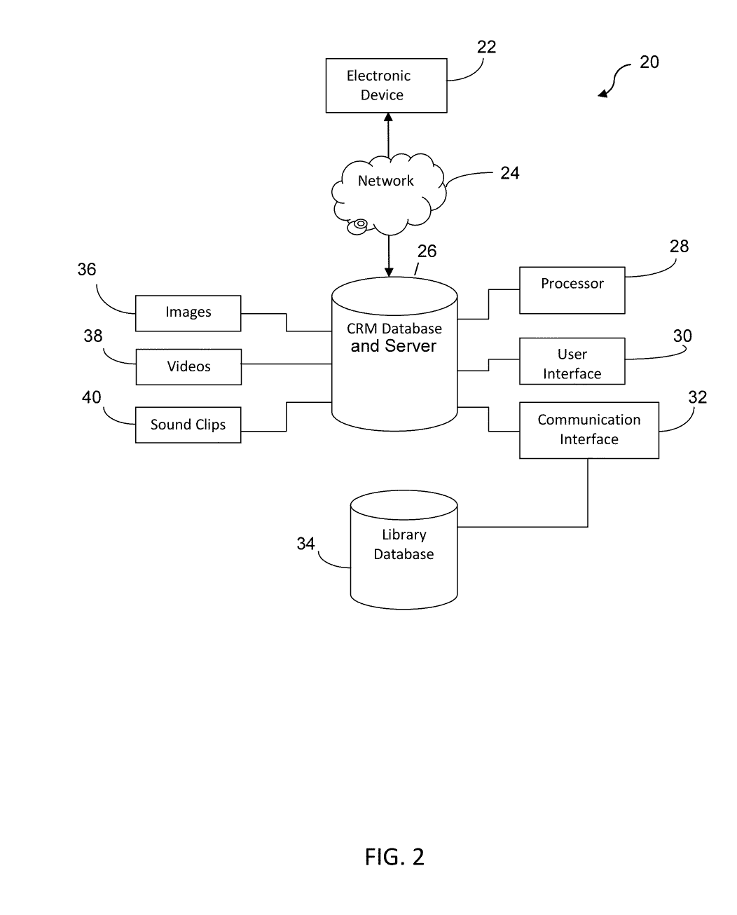

FIG. 2 shows a system generally designated with the reference numeral 20. The system 20 includes an electronic device 22 capable of audio and video data input or capture, and communication of this audio and video data. Preferably the electronic device is a programmable computing device, capable of running applications for managing image capture and audio recording. The electronic device 22 communicates via a network 24 to the server 26.

In one embodiment of the invention, the electronic device 22 is programmed with an application to capture a still image and automatically communicate the image via the network 24 to the server 26. Preferably, the electronic device 22 includes a stored email address or text message number address where any captured image is automatically routed. In this way a busy field technician may snap a picture with the electronic device 22 and that image is automatically routed to the server 26.

Images communicated by the electronic device 22, in one embodiment of the invention, are tagged with geo location information. Such geo location information can be embedded directly into an image or video, or can be streamed as a data packet in conjunction with image and video. In addition to geo location information, other information such as the electronic identification of the electronic device, the user, the company, and the particular business unit, can be embedded in the image or video, or streamed as a data packet in conjunction with the image or video.

Context recognition software can be programmed into the electronic device 22 so that images of a machine, equipment, or other asset can be readily identified from the images captured by the electronic device 22. Context recognition software can also be programmed into the server 26 to achieve context recognition capability, including readily identifying a machine, part or other asset to enable maintenance, analysis or repair of that machine, part or other asset.

The system 20 also includes a contacts relations management (CRM) database. The CRM database stores images 36, videos 38 and sound clips 40, along with customer data. Customer data includes contact information for field technicians and equipment locations for that customer. The server 26 is a general purpose computer including a processor 28, a user interface 30 and a communication interface 32. The communication interface communicates with a library database 34 that details parts lists, part names, images and maintenance manuals associated with equipment operated by the customers stored in the CRM database.

In one embodiment the electronic device 22 includes a means for determining the location of the device. When an image or sound is automatically communicated from the electronic device 22 to the server 26, the location of the device 22 is also included with the communication. Accordingly, the server 26 uses the location data to automatically identify the customer. Other ways of identifying the customer, include the phone number or email address associated with the electronic device user. In any event the customer is identified and the customer's field service technician electronic address is also identified and stored in the CRM database of the server 26.

Once the images 36, videos 38 and sound clips 40, or any subset of these, is associated with a customer in the CRM database of the server 26, the server 26 accesses the library database to populate the CRM database with useful information regarding the customer and equipment operated by the customer. Additionally, particular maintenance and service records can also be linked with the CRM database of the server 26. The server 26 can then automatically dispatch a communication to a service center that can immediately plan to resolve maintenance and repair issues in response to the images 36, videos 38 and sound clips 40 (or subset thereof) dispatched by the electronic device 24.

Importantly the steps described above can happen before the field service technician operating the electronic device 22 can complete a detailed phone call.

A response to the electronic device 22 is automatically generated by the server 26 and dispatched to the electronic device 22. The response can confirm receipt of any previous communication i.e. image, video or sound. The response can also ask questions, including pre-formatted questions such as: “Is there an equipment name plate?”. The response can be managed by machine learning based on context recognition, or generated by human intervention.

The term “automatically communicate” includes storing data, images, and sounds for communication until such a time when a data network is within range. For example, in a mine that is far underground there may not be satellite, cellular or other network connectivity. When an image or video is captured, and a signal is automatically communicated by the electronic device 22, however, the communication is delayed until the electronic device 22 is within range of, and connects to, an appropriate data network.

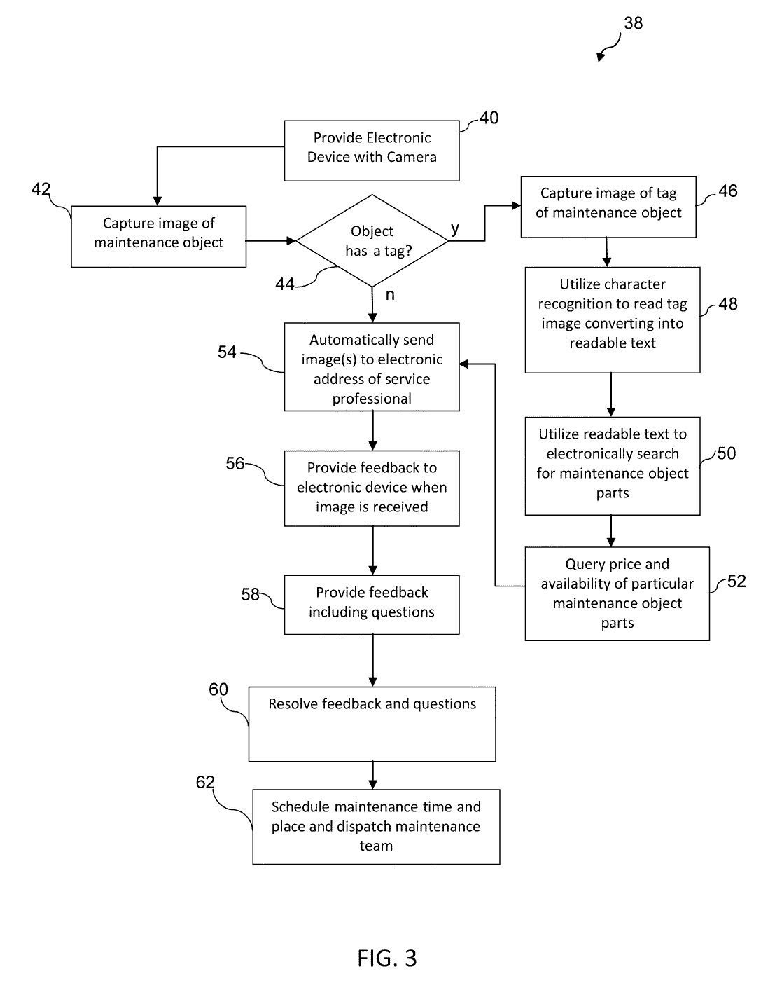

FIG. 3 shows a method in accordance with the present invention, generally designated with the reference numeral 38. The method 38 is utilized with the system of FIG. 2, and this description makes reference to elements described in FIG. 2.

The method 28 includes the step 40 of providing an electronic device 22 with a camera. In one embodiment, the method 38 includes providing an electronic device 22 having a camera and a microphone. In a further embodiment, the electronic device 22 may be equipped with electronic testing components for measuring electrical resistance, electromagnetic field strength and direction, for measuring current, voltage, vibrations and other items that may be relevant to inspecting and maintaining equipment.

The method 38 includes the step 42 of capturing an image, or sound, of a maintenance object, such as mining equipment, bridge, power generator, or other heavy equipment that is not readily moved. The step 44 determines whether the equipment or object has a tag by electronically reading the image to determine whether it is a picture of a tag or not. The step 44 can be performed by the electronic device 22, or by the server 26.

Where the maintenance object has a tag, the step 46 captures an image of the tag. The step 40 utilizes optical character recognition (OCR) algorithms to read the image and convert it into readable text. The step 50 utilizes the readable text and employs the server 26 to electronically search for maintenance object parts in the library database 34. Any text read from images is automatically includes in the CRM database in conjunction with images communicated by the electronic device 22.

The step 52 queries price and availability for the particular maintenance object, various parts associated therewith, and provides a display of a parts list to the CRM database, which can be readily accessed by a service professional.

The step 54 automatically sends images and other data to the electronic address of a service professional, who has access to the CRM database 26. The step 56 sends a notification from the CRM database 26 to the electronic device 22 indicating that the image was received by the server 26.

Step 58 provides additional feedback to the electronic device 22, including questions. The step 58 is initiated by a service professional and is dispatched by the service professional to the electronic address of the electronic device 22. The step 60 resolves feedback and questions though an iterative communication process that could include email, text and voice communications.

Step 62 schedules maintenance time and place and dispatches a maintenance team to the location of the electronic device 22, or the maintenance object.

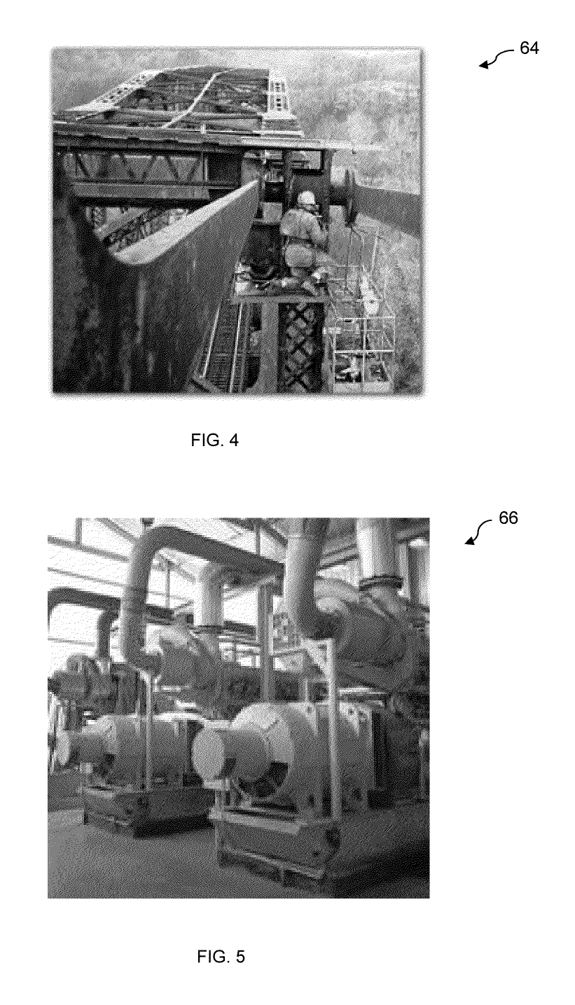

FIG. 4 shows a field technician inspecting a bridge 64. The bridge 64 is part of a transportation system such as rail, or roadways. Because the location of the inspection location is remote, i.e. above ground, efficiency demands that the field technician visit the location of inspection a minimum number of times. The field technician utilizes the electronic device 2 of FIG. 2 of the present invention to automatically send an image of the portions of the bridge 64 to be repaired or maintained in accordance with the method of FIG. 3.

FIG. 5 shows turbines 66 operating as part of a mining operation, or a power generation operation. The turbines are readily imaged by the electronic device 22 of the present invention. When non-routine vibration and sound is generated by the turbines 66, or other elements, these sounds can be recorded and transmitted to a service professional in accordance with the method of FIG. 3, and using the electronic device of FIG. 2.

Although the turbines 66 are shown enclosed in a building, the present invention can be utilized on various turbines, pumps, and even wind turbines that are located outdoors.

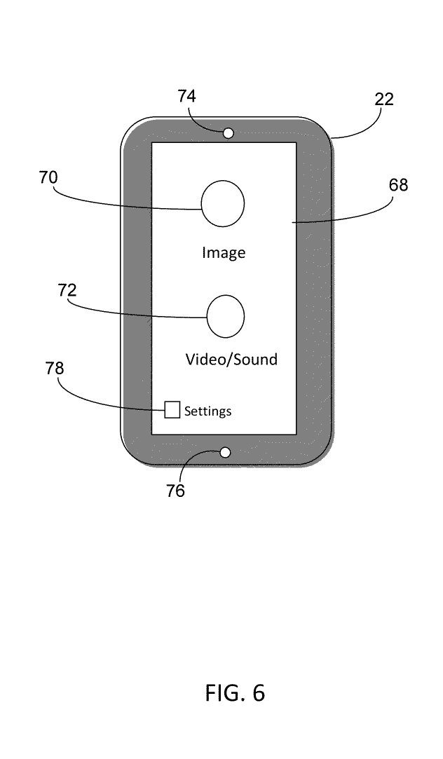

FIG. 6 shows an electronic device 22 having an interface 68 and being programmed with an application. The interface 68 in this ebodiment includes a touch screen. The application, when activated, displays two buttons 70 and 72 displayed. The button 70 is labeled image, and the button 72 is labeled video/sound.

The electronic device 22 includes a camera 74 and selection of the button 70 by a user automatically captures an image using the camera 74, and automatically communicates the image via the network 24 to the server 26 (see FIG. 2). Preferably, the image is automatically communicated without any other action by the user other than a one-click selection of the button 70, or the button 72. Each selection of the button 70, or 72 communicates an image, or video, respectively.

Although the camera 74 is shown on the same side of the electronic device 22 as the interface 68, it can be appreciated that the camera 74 can be on an opposing side of the electronic device 22 so that activation of the camera 74 can capture an image seen by the user at a distance from the electronic device 22, while the user faces and operates the electronic device 22.

The electronic device 22 includes a microphone 76 and selection of the button 72 automatically captures a video with the camera 74 and sound with the microphone 76. The video is of limited duration, the duration being pre-programmed by the electronic device 22. In one embodiment the video is of duration of between 3-20 seconds, and in another embodiment the duration of the video is between 5-10 seconds. In yet another embodiment, the application has a settings button that activates a dashboard interface to enable a user to program the duration of any video captured and sent by the application.

In one embodiment of the invention, the geolocation of the electronic device 22 can be determined on-line or off-line by the electronic device 22. Whenever a new image is captured the application automatically tags it with location data from a Geolocation Application Programming Interface (API) proposed by W3C in their Geolocation APA Specification and related recommendations of 24 Oct. 2013, published at W3.org. Whenever the electronic device reaches a location having network coverage, electronic device application automatically uploads images and other to the server. The server uses geolocation data to construct links that point to a mapping service using the library database. A service technician can immediately determine location of the user of the electronic device 22, and map relevant machinery known to be at that location. The service technician can make recommendations for repair of the machine imaged by the electronic device, and also make recommendations for period maintenance of other known machines at that location, as well as suggestions for consumable parts and supplies. This represents an efficient way to minimize down time of machines at the location of the electronic device 22.

Benefits of the present invention are numerous and the invention can be readily adapted for use in parts management system, plant operations system and enterprise asset management systems. The invention is useful for a variety of industries including mining, telecommunications, power generation and distribution systems. Power generation systems include including coal, solar, wind, nuclear, geothermal and other power generation systems.

Equipment reliability is of great importance to these industries and applications. The present invention helps to develop and maintain appropriate maintenance strategies by equipment type, reduced equipment failure through prioritization of inspection and maintenance of key assets. Improving plant and equipment reliability results from a comprehensive understanding of equipment health and plant operations. The present invention can also improve decision making and more informed business cases and long-term forecasting for capital investment projects.

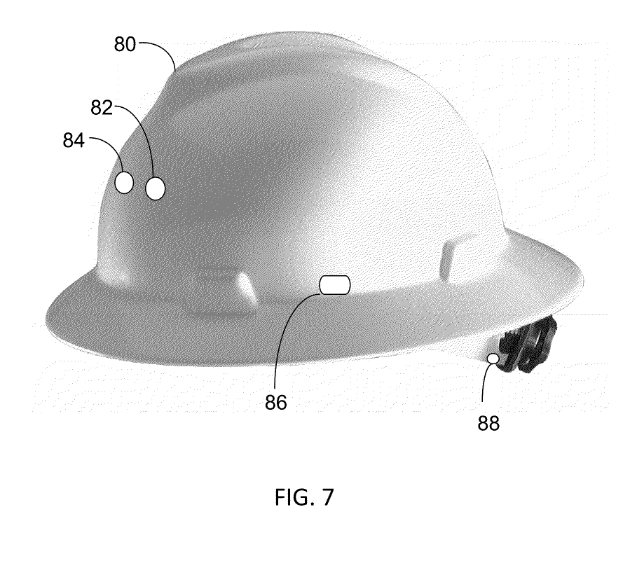

FIG. 7 shows a hard hat 80 including an electronic device mounted within the hard hat 80 in accordance with the present invention. The hard hat 80 includes a protective outer shell.

Dual cameras 84 and 82 mount on the protective shell to enable stereoscopic imaging. Stereoscopic imaging enables two channels of video feed to achieve redundancy and the ability to determine precise distances of objects imaged when the video stream generated by the dual cameras 84 and 82 is analyzed.

A microphone 86 mounts on a lateral side of the hard hat 80. The microphone 86 and the dual cameras 84 and 82 attach in operative communication with the electronic device. Preferably the dual cameras 84 and 82, and the microphone are hard wired to the electronic device.

The electronic device is a module enclosed within a water and impact resistant case. The electronic device is fixed within the hard hat 80, being attached within the protective shell.

The cameras 82 and 84 and the microphone 86 to enable wires to extend through the hard hat to enable stereoscopic viewing and sound capture data to be communicated to the electronic device.

A flexible suspension element attaches within the helmet 80 that comfortably supports the hard hat on the head of a wearer. The electronic device, in this embodiment has an interface. The interface, in this embodiment, has an integrated operation switch 88 controllable by the wearer. The switch 88 is preferably located on the flexible suspension element. In an alternate embodiment, the electronic device is voice-activated and the electronic device includes a voice recognition module in communication with the microphone to enable voice-activation and control.

For example, simple voice commands can be pre-configured or selected by the user. Commands may include “camera on”, “microphone on”, “camera zoom”, “camera off”, “snap shot” and “microphone off” for controlling the camera operation, microphone operation, camera object resolution among other traditional camera and microphone functions.

In one embodiment a telephonic cellular or radio module is integrated within the helmet 80 and in electronic communication with the microphone 86 to enable a wearer to engage in telephonic communication while collecting video images with the cameras 82 and 84.

While the present invention is described in terms of various embodiments, these are by way of example. The true scope of the invention is described by the appended claims.

I claim:

1. A method of providing efficient maintenance of equipment, comprising:
providing an electronic device having a camera, and an interface having buttons, the electronic device being connectable to a communications network;
actuating a button on the electronic device interface to capture an image of equipment to be maintained; and
automatically dispatching an electronic message including the captured image to an electronic address of a service center without requiring additional steps.

2. The method of claim 1, wherein the electronic device is not connected to a communications network and the step of automatically dispatching an electronic message includes storing the image on the electronic device, detecting when a communications network is within range, and dispatching the electronic message after the communications network is detected.

3. The method of claim 2, wherein the electronic message includes geolocation data embedded in the electronic message.

4. The method of claim 3, wherein the electronic address of the service center is pre-programmed in the electronic device to enable automatic dispatch of the electronic message.

5. The method of claim 4, wherein the equipment includes a tag including data detailing the model number of the equipment, the image of the mining equipment includes an image of the tag and the image is read using optical character recognition algorithms by the electronic device.

6. The method of claim 4, wherein the service center includes a server, the equipment includes a tag including data detailing the model number of the equipment, the image of the mining equipment includes an image of the tag and the image is read using optical character recognition algorithms by the server.

7. The method of claim 6, wherein the server includes a customer relations management database, the tag data is stored in the customer relations database and associated with a customer, a location, and field technician contact information.

8. The method of claim 7, wherein the server is connected in operative communication with a library database, and the tag data enables the server to assemble data from the library database for storage in the customer relations management database, wherein the assembled data includes a parts list for the equipment to be repaired.

9. The method of claim 8, wherein the service center database communicates the parts list to the service center technician to enable parts to be ordered and services scheduled.

10. The method of claim 8, wherein the electronic device is integrated into a wearable hard hat that includes a microphone, and the method includes recording sounds made by the mining equipment, and automatically dispatches an electronic message including the sounds to an electronic address of a service center.

11. The method of claim 10, wherein the hard hat includes stereoscopic cameras to enable data communicated by the cameras to reveal distance of any objects viewed by the cameras.

12. The method of claim 11, wherein the method includes the step of capturing an image of the equipment, and communicating the image in the electronic message.

13. The method of claim 12, wherein the electronic device detects geolocation data, and the step of dispatching an electronic message includes dispatching an electronic message with the geolocation data.

14. The method of claim 13, wherein the electronic device embeds the geolocation data in the captured image.

15. The method of claim 1, wherein the electronic device includes an accelerometer, and placement of the electronic device on the equipment measures vibration and captures vibration data, the vibration data is communicated with the electronic message.

16. A system for troubleshooting capital equipment including mining equipment and bridges, comprising:
a service center server having a server;
a customer relations management database in operative communication with the server;
a library database in communication with the customer relations management database, the library database stores parts lists, part numbers and images of parts for the capital equipment;
an electronic device in operative communication with the server, the electronic device including a camera for capturing images of the capital equipment, a microphone for recording sound from the capital equipment, and a data communication terminal, the electronic device being programmed to store an electronic address of a service center, and to automatically dispatch images from the camera, and sounds recorded by the microphone, to the service center server.

17. A system as set forth in claim 16, wherein the electronic device include a means for determining location, and the data communications terminal automatically communicates the location of the electronic device to the service center server, the service center server utilizes the location of the electronic device to determine the customer, and associates the images and sounds with a customer in the customer relations management database.

18. A system as set forth in claim 16, wherein the electronic device includes an interface that prompts the field technician to send the images and sounds to the service center electronic address.

19. A method of providing efficient repair of equipment, comprising:
providing an electronic device having a camera;
capturing an image of the equipment; and
automatically dispatching an electronic message including the captured image to an electronic address of a service center;
receiving the image with a server located at the service center;
gathering data from the image and storing the data in a customer relations management database;
gathering additional data pertaining to the equipment from a library database; and
merging the additional data into the customer relations management database to enable a service professional to schedule maintenance and service for the equipment.

20. The method of claim 19, wherein providing an electronic device includes providing a hard had equipped with a microphone, and the step of capturing an image of the equipment includes capturing a sound recording of the equipment, the sound recording has a pre-determined duration of between 5-10 seconds and the sound recording is transmitted to the customer relations management database.
